(19) United States
(12) Patent Application Publication
(10) Pub. No.: US 2025/0004806 A1
(43) Pub. Date: Jan. 2, 2025

(54) PROCESSOR WITH VIRTUALIZABLE SIGNAL MONITORS

(71) Applicant: ADVANCED MICRO DEVICES, INC., Santa Clara, CA (US)

(72) Inventors: Mark Unruh Wyse, Bellevue, WA (US); Anthony Thomas Gutierrez, Seattle, WA (US); Stephen Alexander Zekany, Redmond, WA (US); Paul Blinzer, Carnation, WA (US)

(21) Appl. No.: 18/216,310

(22) Filed: Jun. 29, 2023

(51) Int. Cl. G06F 9/455

(52) U.S. Cl. CPC G06F 9/45558; G06F 2009/4557; G06F 2009/45583

(57) ABSTRACT

A processing unit (e.g., a CPU) executes multiple processes, such as multiple virtual machines, wherein each process employs virtual signals and virtual signal monitors to support signaling between the process and one or more accelerators. A hardware signal manager (HSM) assigns each virtual signal to a physical signal of the system and assigns each virtual signal monitor to a physical signal monitor. Based on a process' interactions (e.g., signal operations) with a virtual signal monitor, the HSM executes corresponding interactions at the assigned physical signal monitor. The HSM thus virtualizes the physical signal monitors for the executing processes.

### BACKGROUND

To improve processing efficiency and conserve power, some processing systems employ one or more accelerators to perform designated operations on behalf of a central processing unit (CPU). For example, some processing systems employ a graphics processing unit (GPU) to perform graphics operations, an artificial intelligence (AI) accelerator to perform AI operations, a digital signal processor (DSP) to perform signal processing operations, and the like. To facilitate communication between the accelerators and the CPU, some processing systems employ signals, wherein each signal is a shared memory object that can be accessed by the CPU and one or more accelerators to share information. Examples of signals include doorbell signals that notify agents (e.g., one or more accelerators) that work is available, and completion signals that notify agents (e.g., a CPU or accelerator) when assigned work is available. However, existing signal implementations are not well-suited for efficient signal handling, including for systems that execute a relatively high number of processes, resulting in a large number of signals to manage.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a system that employs virtualizable physical signal monitors to monitor signals and execute signal operations in accordance with some embodiments.

FIG. 2 is a block diagram of a hardware signal manager (HSM) of FIG. 1 in accordance with some embodiments.

FIG. 3 is a diagram illustrating an example of the HSM of FIG. 2 assigning, at different times, different subsets of virtual signal monitors to a set of physical signal monitors in accordance with some embodiments.

FIG. 4 is a flow diagram of a method of virtualizing physical signal monitors at a system in accordance with some embodiments.

### DETAILED DESCRIPTION

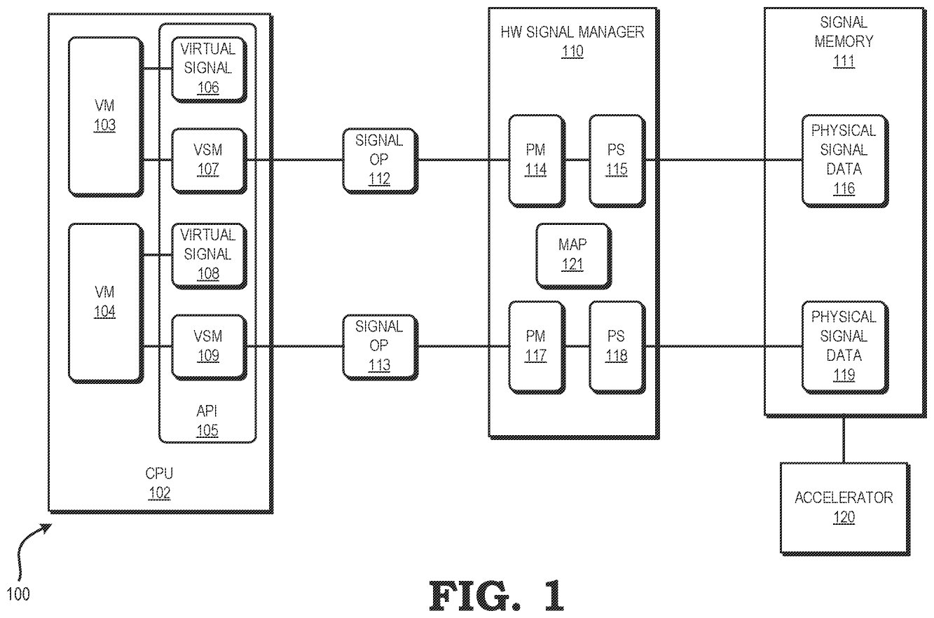

FIGS. 1-4 illustrate circuitry and techniques for virtualizing a set of physical signal monitors at a system. A processing unit (e.g., a CPU) executes multiple processes, such as multiple virtual machines, wherein each process employs virtual signals and virtual signal monitors to support signaling between the process and one or more accelerators. A hardware signal manager (HSM) assigns each virtual signal to a physical signal of the system and assigns each virtual signal monitor to a physical signal monitor. Based on a process' interactions (e.g., signal operations) with a virtual signal monitor, the HSM executes corresponding interactions at the assigned physical signal monitor. The HSM thus virtualizes the physical signal monitors for the executing processes, thus providing a relatively simple way for the different processes to employ physical signal monitors, thereby enhancing processing efficiency. Further, the HSM allows the system to manage a relatively high number of signals for different executing processes while employing a relatively small set of physical signal monitors.

To illustrate, in some embodiments a system includes a number of agents, including at least one CPU and an accelerator. To communicate, the agents employ a set of signals, wherein each signal is a shared memory-backed object assigned a corresponding memory address. Each signal includes both a signal value and a signal condition. A signal is typically waited on by one or more agents, wherein each agent takes action when the signal condition is met by the corresponding signal value (e.g., the signal condition is met when the signal value is less than one). A signal is sent by an agent when the agent performs a write using an atomic memory operation to the corresponding address. An example of a signal is a doorbell signal, wherein the signal is used by one agent (e.g., a CPU) to indicate to another agent (e.g., an accelerator) that work (e.g., one or more commands) is available to be executed. Another example of a signal is a completion signal, wherein the signal is used by one agent to indicate to another agent that assigned work has been completed.

To reduce the overhead associated with signal management by software, the system employs multiple physical monitors (PMs), where each PM is circuitry configured to monitor a corresponding physical signal, and execute operations with respect to, a corresponding signal. Furthermore, the system employs an HSM to virtualize the PMs, allowing executing software processes to interact with the PMs via a set of virtual signals. For example, in some embodiments the system executes multiple virtual machines. Each virtual machine is configured to employ one or more virtual signals, and virtual signal monitors (VSMs), for signaling, using a corresponding virtual address space known to the respective virtual machine. The HSM maps a physical signal and corresponding PM to each VSM. The system is configured to forward to the HSM (e.g., via a runtime application program interface (API)) all virtual machine interactions with a VSM, and the HSM causes the mapped PM to perform the corresponding interaction for the mapped physical signal. For example, in response to a virtual machine issuing a signal operation to a VSM, the HSM issues a corresponding operation to the mapped PM. The HSM thus manages all mapped signals and monitors via the virtual signals and monitors, allowing arbitrary mixes of mapped signals and monitors to occupy the system at any time, regardless of which process (e.g., virtual machine or address space) each belongs to. Further, by mapping the physical signals and PMs to different virtual signals and VSMs at different times, the HSM allows the system to support a relatively high number of virtual signals with a relatively small number of physical signals and PMs.

FIG. 1 illustrates a system 100 in accordance with some embodiments. The system 100 is generally configured to execute sets of instructions (e.g., computer programs) in order to carry out operations, as specified by the sets of instructions, on behalf of an electronic device. Accordingly, in different embodiments the system 100 is part of any one of a number of electronic devices, such as a desktop or laptop computer, a server, a smartphone, a tablet, a game console, and the like.

To facilitate execution of instructions, the system 100 includes a CPU 102 and a set of accelerators (e.g., accelerator 120). It will be appreciated that the number of accelerators illustrated at FIG. 1 is an example only, and that in other embodiments the system 100 includes more accelerators. In addition, in some embodiments the system 100 includes additional circuitry, not illustrated at FIG. 1, that supports the execution of instructions, such as one or more memory controllers, one or more input/output controllers, one or more memory modules, and the like, or any combination thereof. In some embodiments the CPU 102 and the accelerators 120 are part of a single integrated circuit, while in other embodiments the accelerator 120 is external to the system 100. In other embodiments, the CPU 102 and the accelerator 120 are part of the same integrated circuit package but are incorporated in separate integrated circuit dies.

The CPU 102 is generally configured to execute sets of instructions for the system 100. Thus, in some embodiments, the CPU 102 includes one or more processor cores, wherein each processor core includes one or more instruction pipelines. Each instruction pipeline includes circuitry configured to fetch instructions from a set of instructions assigned to the pipeline, decode each fetched instruction into one or more operations, execute the decoded operations, and retire each instruction once the corresponding operations have completed execution. In the course of executing at least some of these operations, the CPU 102 generates operations to be executed by one of the accelerator 120.

The accelerator 120 is circuitry configured to execute specified operations on behalf of the CPU 102. For example, in different embodiments the accelerator is a GPU, a vector processor, a general-purpose GPU (GPGPU), a non-scalar processor, a highly-parallel processor, an artificial intelligence (AI) processor, an inference engine, a machine learning processor, a DSP, a network controller, and the like.

To support communication between the CPU 102 and the accelerator 120, the system 100 is configured to support a signals architecture, such as a Heterogeneous Systems Architecture (HSA). In particular, the CPU 102 and the accelerator 120 are configured to communicate specified information, such as status information, via a set of signals, wherein each signal is a shared memory object accessible by the CPU 102 and the accelerator 120. To support signals, the system 100 includes a signal memory 111 including a plurality of addressable entries, wherein each entry corresponds to a different signal. To change the state of a signal, the accelerator 120 or the CPU 102 performs a write operation to the memory address corresponding to the signal. The value written by the write operation sets the value for the signal corresponding to the memory address. The values for different signals are represented at FIG. 1 as signal data 116 and signal data 119. In some embodiments, the signal memory 111 is a standalone memory. In other embodiments, the signal memory 111 is a region of system memory allocated by an operating system.

To illustrate via an example, in some embodiments an operating system (not shown) or other software executing at the CPU 102 assigns a memory address as a signal for the accelerator 120, wherein the value of the signal is to indicate whether the accelerator 120 is available to handle additional work items from the CPU 102. Thus, when the accelerator 120 determines that it is able to process more work items, the accelerator 120 writes a specified value to the memory address, at the signal memory 111, assigned to the signal. In response, the CPU 102 provides one or more additional work items accelerator 120. It will be appreciated that, in different embodiments, the signal memory 111 stores the values for any number of signals, and to indicate any of a number of statuses or other information, such as signals indicating completion of one or more work items by an accelerator, signals indicating that a specified action is to be taken by the CPU 102, and the like.

As noted above, one way for the CPU 102 and the accelerator 120 to determine the status of a given signal is to poll the signal, such as by performing a read operation at the memory address specified by the signal. However, this requires the CPU 102, for example, to repeatedly execute polling loops for the signal, consuming CPU resources and preventing asynchronous communication of signal statuses. Accordingly, to facilitate more efficient communication of signals, as well as more sophisticated signal handling, the system 100 includes a hardware signal manager (HSM) 110. The HSM 110 is circuitry that includes a plurality of physical signal monitors (PMs), such as PMs 114 and 117. The HSM 110 is further configured to assign each PM to a physical signal (PS). For example, in the illustrated embodiment the HSM 110 has assigned the PM 114 to a PS 115 and the PM 117 to a PS 118. Each PS is backed by corresponding signal data at the signal memory 111, wherein the signal data at the signal memory 111 indicates the value for the corresponding PS. Thus, in the illustrated example, the value for PS 115 is indicated by signal data 116 and the value for PS 118 is indicated by the signal data 119.

In some embodiments, and as described further below, the PMs are assigned by the HSM 110 to physical signals via a mapping table (not shown at FIG. 1). Accordingly, at different times the HSM 110 assigns a given PM to different physical signals. Each PM is circuitry configured to implement basic signal operations (loads, stores, atomic memory operations at the signal memory 111) and signal wait semantics. For example, in some embodiments the PM circuitry is configured to monitor a signal (and the corresponding signal data) for a specified value, and in response to the signal being at the PM circuitry takes specified action, such as issuing a notification. Each PS represents circuitry that implements the functionality of signal memory accesses (that is, accesses to the signal data corresponding to the signal at the signal memory 111), including loads, stores, and atomic memory operations (also called atomic read-modify-write operations). The PM and PS circuitry thus together implement signals and signal operations in hardware, and thereby reduce or obviate the need for software polling of the signal, and software implementation of other signal operations, thus improving processing efficiency at the system 100.

Because the PMs and corresponding physical signals are implemented in hardware, each PM and PS consumes circuit area at the system 100. Accordingly, in at least some embodiments it is not feasible to implement a different PM and PS for each signal to be used by software executing at the system 100. For example, in the illustrated embodiment, the CPU 102 executes two different virtual machines (VMs), designated VM 103 and VM 104, respectively. In some embodiments, the VMs 103 and 104 are configured such that together implement more signals than there are PMs and physical signals at the HSM 110. In other embodiments, each of the VMs 103 and 104 individually implement more signals than there are PMs and physical signals at the HSM 110. Accordingly, to support a relatively high number of signals for executing software while employing a smaller number of PMs and physical signals, the system 100 is configured to virtualize the PMs and corresponding physical signals.

To support virtualization, the CPU 102 executes an API 105 that communicates with the HSM 110 based on commands generated by the VMs 103 and 104. The API 105 and the HSM 110 provide a layer of abstraction between the VMs 104 and 104 and the PMs and physical signals at the HSM 110. To illustrate, in some embodiments a VM instantiates a signal by sending a specified command to the API 105. In response to the specified command, the API 105 creates a virtual signal (VS), such as VS 106 and VS 108, and for each virtual signal creates a virtual signal monitor (VSM), such as VSM 107 for VS 106 and VSM 109 for VS 108. In response to a request from a VM to instantiate a signal, the API 105 sends a signal assignment request (not shown) to the HSM 110. In response, the HSM 110 assigns a PS to the VS created by the API 105, and assigns a PM to the PS, as well as the VSM corresponding to the signal. The HSM 110 maintains a data structure, designated map 121, that stores information indicating, for each VS and VSM, the respective assigned PS and PM.

Each of the VMs 103 and 104 then interacts with the corresponding virtual signals and VSMs by providing signal commands to the API 105. In at least some embodiments, these signal commands are commands configured for signal operations and signal monitors. That is, each VS and VSM appears to the corresponding VM as if it were a local resource, and each VM interacts with the corresponding virtual signals and VMs via commands configured to interact with a local signal or local signal monitor dedicated to that VM. The API 105 and the HSM 110 together implement these commands at the system 100, thereby virtualizing the physical resources of the HSM 110 (e.g., the PMs and corresponding physical signals) as local resources of each of the VMs 103 and 104.

To illustrate, a VM interacts with a virtual signal or VSM by issuing a signal operation to that virtual signal or VSM. The VM issues the signal operation by sending a command corresponding to the signal operation to the API 105. Examples of these signal operations include identifying the signal value, changing a signal value, identifying a signal condition, and the like. In response to receiving a signal operation for a VS, the API 105 forwards the signal operation (e.g., signal operations 112 and 113) to the HSM 110. In response to receiving a forwarded signal operation, the HSM 110 identifies the PS and PM assigned to the signal indicated by the forwarded signal operation. The HSM 110 then causes the identified PS and PM to execute the signal operation.

To illustrate via an example, the VM 103 issues a signal operation command targeting the VSM 107. For purposes of the example, it is assumed that the signal operation command is a request to change the value of the VS 106. In response to the signal operation command from the VM 103, the API forwards the signal operation 112 to the HSM 110. The HSM 110 determines, based on the map 121, that the VS 106 and the VSM 107 have been assigned to PS 115 and the PM 114, respectively. The HSM 110 then causes the PM 114 and the PS 115 to execute the forwarded operation. For this example, the PM 114 and the PS 115 together perform a write operation at the signal memory 111 to set the value of the signal data 116 to the value indicated by the signal operation 112. Thus, the particular hardware used to execute the signal command is abstracted from the VM 103. This allows the VM 103 to employ existing signal interface software to manage signals, including signal interface software that has not been reconfigured to employ hardware physical signal monitors.

In some cases, a given signal is not mapped to a corresponding physical signal. For example, in some cases a signal that is not critical to the performance of the system or that is only checked periodically in a non-polling manner may not require a physical signal and physical monitor, but instead is implemented as virtual memory object by a virtual machine. Accordingly, in some embodiments, the HSM 110 is configured to identify, based on the map 121, when a signal operation targets a VS that is not assigned a corresponding PS. In response to identifying such a virtual signal, the HSM 110 is configured to forward the operation directly to a cache or device memory for execution. In some embodiments a bit in a signal object is used to indicate if there are any monitors associated with the signal. For example, a bit value of 1 indicates that there are one or more monitors associated with the signal, and a value of 0 indicates there are no monitors associated with the signal.

In some cases, the result of a particular signal operation may not impact the operations of the VM that issued the signal operation. Such operations are referred to as non-impactful operations herein. The HSM 110 is configured to identify non-impactful operations based on information provided when the signal is created and, in response to identifying a non-impactful operation, to forego performing the operations, thus conserving system resources.

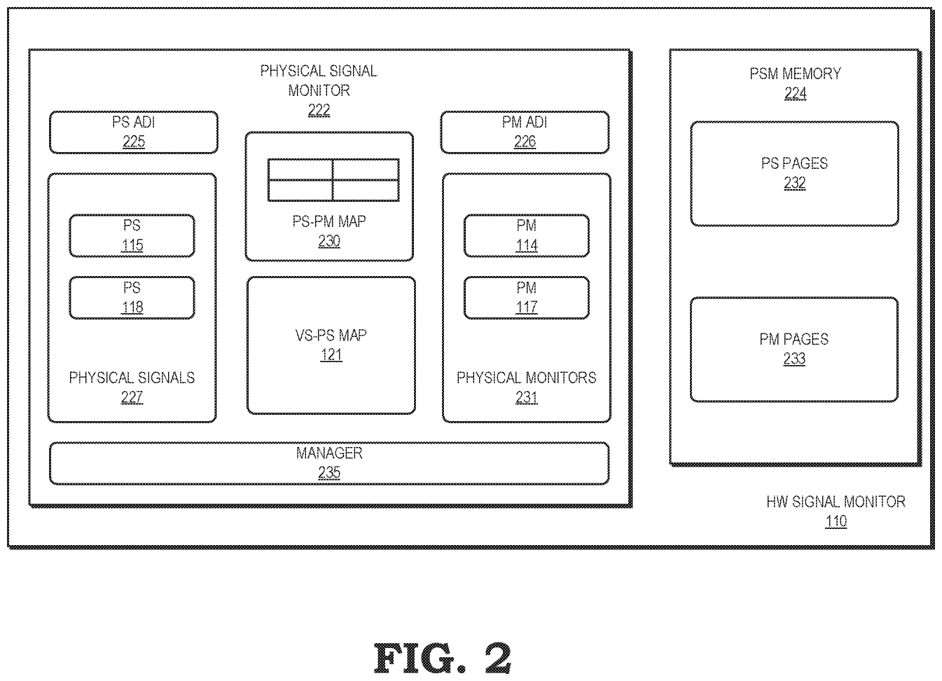

FIG. 2 illustrates a block diagram depicting aspects of the HSM 110 in accordance with some embodiments. In the depicted example, the HSM 110 includes a physical signal monitor (PSM) 222 and a PSM memory 224. The PSM memory 224 is a memory structure, such as one or more caches, higher-level memory, or a combination thereof configured to store data on behalf of the PSM 222. For example, in the illustrated embodiment the PSM memory 224 stores a set of physical signal (PS) pages 232 and a set of physical monitor (PM) pages 234.

The PSM 222 is circuitry configured to manage and execute signal operations for physical signals, in response to signal operations received from the VMs 103 and 104 via the API 105. Accordingly, in the illustrated embodiment the PSM 222 includes a physical signal Assignable Device Interface (ADI) 225 (referred to as PS ADI 225), a physical monitor ADI (PM ADI) 226, physical signals (PS) 227 (including PS 115 and PS 118), physical monitors 228 (including PMs 114 and 117), as PS-PM map 230, and a manager 235. The PS ADI 225 is a set of circuitry, software, firmware, or a combination thereof, configured to assign PS resources based on commands received from the API 105. For example, in some embodiments the PS ADI 225 is configured to assign one of the PS 227 to a virtual signal in response to a request from the API 105, such as a request triggered when a VM requests allocation of a signal. Similarly, the PM ADI 226 is a set of circuitry, software, firmware, or a combination thereof, configured to assign PM resources based on commands received from the API 105. For example, in some embodiments the PM ADI 226 is configured to assign one of the PM 227 to a virtual signal in response to a request from the API 105, such as a request triggered when a VM requests allocation of a signal monitor.

The PS-PM map 230 is a data structure, such as a table, that stores a mapping of PS to PMs. In some embodiments, the PS-PM map 230 associates every PM with one corresponding PS, and the PS is indicated in the state of PM monitor. In some embodiments, the PS-PM map 230 is indexed by PS and the output of the PS-PM map 230 is a bitmask indicating which physical monitors are associated with each PS. In other embodiments, the PS-PM map 230 is implemented as a content addressable memory (CAM) where each entry represents one PS to PM mapping, and in some cases multiple valid entries exist for a given PS, with each entry pointing to a different PM.

The manager 235 is circuitry configured to manage the mapping of virtual signals to physical signals, and therefore to set the data stored at the map 121. For example, in response to a request from the API 105 to assign a PS to a VS, the manager 235 is configured to identify a PS to assign, and to store data at the map 121 indicating that the identified PS is assigned to the VS indicated by the request. In some embodiments, the number of VS instantiated by the API 105, over time, exceeds the number of PS, and PM, available at the HSM 110. Accordingly, in some embodiments the manager 235 employs a specified policy to determine which virtual signals should be mapped at any time. In some embodiments the manager 235 is configured to prefetch signals to the PSM memory 224 from device memory in order to reduce physical signal misses. In some embodiments, the manager 235 is configured to manage signal pages that are mapped to the physical device. This includes allocating new pages when the API 105 requests more signals. In some embodiments, signal page translations are tagged with special page table attributes or bits to keep the pages pinned in system memory (if they are spilled from device to system memory), or to indicate properties about the signals located on the page. For example, in some embodiments a page table bit is employed to indicate that none of the signals on the page have an associated monitor.

In some embodiments, the manager 235 is configured to map PMs to VSMs in response to requests from the API 105. Similar to the physical signals and virtual signals, in at least some cases the number of PMs at the HSM 110 is smaller than the number of VSMs over time. Accordingly, in some embodiments the manager 235 employs a specified policy to determine which VSMs are mapped to a PM at a given time. For example, in some embodiments, the manager 235 is configured to identify when a VSM, or VS, is no longer in use, or has not been accessed in a threshold amount of time. In response, the manager 235 reassigns the corresponding PM, PS, or any combination thereof to a different VSM or VS respectively. In some embodiments, the manager 235 is configured to limit the number of physical monitors assigned to VSMs that are associated with the same physical signal to prevent the assignment of too many physical monitors for one signal.

As noted above, the HSM 110 is generally configured to assign PS and PMs to VS and VSMs, respectively. Further, in some embodiments the number of VS and VSMs implemented at the CPU 102 over time exceed the number of PS and PMs at the HSM 110. Accordingly, the HSM 110 is configured to, based on specified selection and assignment policies, assign a given PS to different virtual signals at different times. Similarly, the HSM 110 is configured to, based on the specified selection and assignment policies, assign a given PM to different virtual signal monitors at different times. This allows the system 100 to implement a relatively high number of virtual signals and virtual signal monitors with a relatively small number of physical signals and physical signal monitors, thus providing scalability for hardware signal monitors.

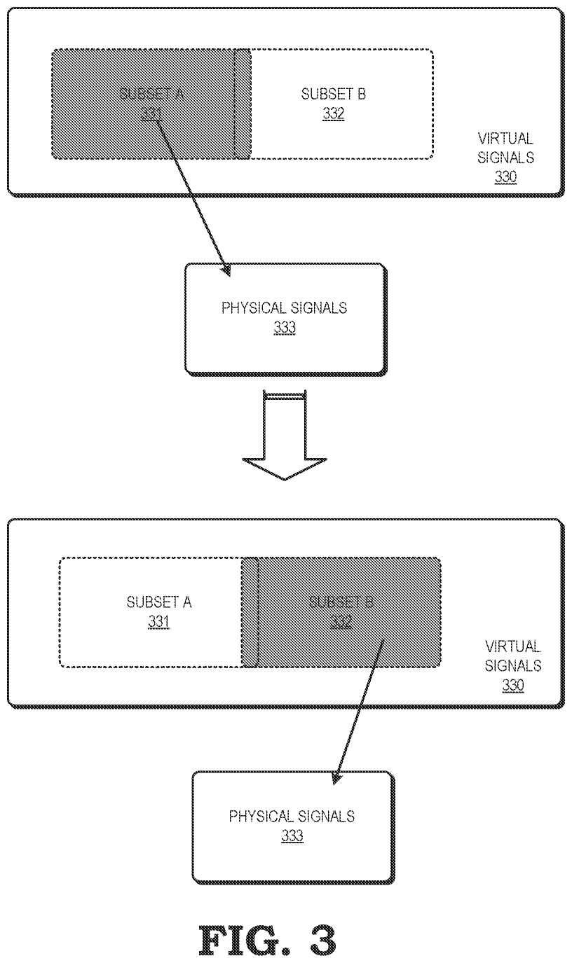

An example of the HSM 110 assigning physical signals to different virtual signals is illustrated at FIG. 3 in accordance with some embodiments. In the depicted example, it is assumed that, over time, the API 105 implements a set of virtual signals 330. For purposes of the example, the set of virtual signals 330 is assumed to include two subsets of virtual signals, designated subset 331 and subset 332. The different subsets 331 and 332 represent the virtual signals implemented by the API 105 and CPU 102 at different times. The subsets 331 and 332 are illustrated as partially overlapping to indicate that the subsets 331 and 332 include some of the same virtual signals, and also each include at least one virtual signal not included in the other subset.

FIG. 3 also depicts a set of physical signals 333, representing all of the physical signals supported by the HSM 110. In the illustrated example, at a first time the HSM 110 has assigned the subset 331 of virtual signals to the set of physical signals 333. At a subsequent time, and based on the specified selection and assignment policy, the HSM 110 has assigned the subset 332 of virtual signals to the set of physical signals 333. Thus, in the depicted example, at different times the HSM 110 assigns the same set of physical signals to different subsets of virtual signals implemented at the CPU 102.

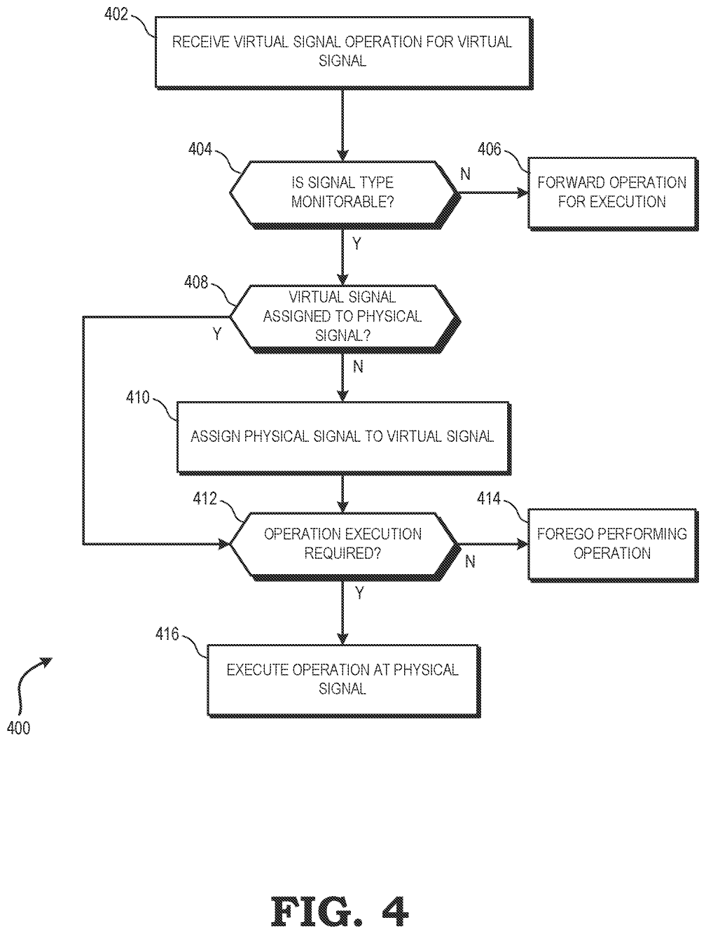

FIG. 4 illustrates a flow diagram of a method 400 of a system virtualizing a set of physical signals and physical signal monitors in accordance with some embodiments. The method 400 is described with respect to an example implementation at the system 100 of FIG. 1, but it will be appreciated that in other embodiments the method 400 is implemented at systems having different configurations.

At block 402, a VM (e.g., the VM 104) issues a signal operation for a virtual monitor associated with a virtual signal (e.g., the virtual monitor virtual signal 108) by sending a command to the API 105. In response, the API 105 sends the signal operation (e.g., signal operation 113) to the HSM 110. At block 404, the HSM 110 determines whether the signal operation is for signal having a monitorable signal type. In some embodiments, the HSM 110 maintains a table of signals and signal attributes for each physical signal. The signal attributes indicate whether the corresponding signal is monitorable or not—that is, whether the signal is of a type that is monitored or of a type that is not monitored. In response to identifying the signal operation as being associated with a non-monitorable signal, the method flow moves to block 406 and the HSM 110 forwards the operation to the signal memory 111 for execution. For example, in some embodiments the signal operation is a write operation to write a signal value, and the HSM 110 forwards the write operation to the signal memory 111 to write the signal value to the memory location corresponding to the signal.

If, at block 404, the signal operation is for a monitorable signal, the method flow moves to block 408 and the HSM 110 determines whether the signal associated with the signal operation has been assigned a physical signal. If so, the method flow moves to block 412, described below. If the signal operation is for a signal that has not been assigned a physical signal, the method flow moves to block 410 and the HSM 110 assigns the virtual signal a physical signal and assigns a physical monitor to the physical signal.

At block 412, the HSM 110 determines if the signal operation is a non-impactful operation. If so, the method flow moves to block 414 and the HSM 110 forgoes performing the operation, thereby conserving system resources. If the signal operation is an impactful operation, the method flow moves to block 416 and the physical monitor assigned to the physical signal executes the signal operation.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a system, a first virtual signal monitor request from a first virtual signal monitor associated with a first virtual signal; and
in response to the first virtual signal monitor request, executing a first signal operation at hardware signal monitor circuitry (HSM) of the system.

2. The method of claim 1, wherein the first signal operation comprises one of a load operation, a store operation, an atomic memory operation, and a signal wait operation.

3. The method of claim 1, further comprising:
mapping, at the HSM, a first physical signal of the system to the first virtual signal.

4. The method of claim 1, further comprising:
in response to receiving a second virtual signal monitor request associated with a second virtual signal, forwarding, at the HSM, the second virtual signal monitor request to a memory for execution.

5. The method of claim 4, wherein forwarding comprises forwarding the second virtual signal monitor request in response to determining at the HSM that the second virtual signal is a non-monitored signal.

6. The method of claim 1, further comprising:
in response to receiving a second virtual signal monitor request associated with a second virtual signal, forgoing execution of the second virtual signal monitor request based on an identified implication of the execution.

7. The method of claim 1, wherein the HSM includes a plurality of physical signal monitors and further comprising:
assigning, at the HSM, a first physical signal monitor of the plurality of physical signal monitors, to the first virtual signal monitor.

8. The method of claim 7, further comprising:
reassigning, at the HSM, the first physical signal monitor to a second virtual signal monitor.

9. A system, comprising:
a processor to execute a first virtual signal monitor associated with a first virtual signal; and
hardware signal monitor circuitry (HSM) to execute a first signal operation in response to a first virtual signal monitor request from the first virtual signal monitor.

10. The system of claim 9, wherein the first signal operation comprises one of a load operation, a store operation, an atomic memory operation, and a signal wait operation.

11. The system of claim 9, wherein the HSM is to:
map a first physical signal of the system to the first virtual signal.

12. The system of claim 9, wherein the HSM is to:
in response to receiving a second virtual signal monitor request associated with a second virtual signal, forward the second virtual signal monitor request to a memory for execution.

13. The system of claim 12, wherein the HSM is to forward the second virtual signal monitor request in response to determining that the second virtual signal is a non-monitored signal.

14. The system of claim 9, wherein the HSM is to:
in response to receiving a second virtual signal monitor request associated with a second virtual signal, forgo execution of the second virtual signal monitor request based on an identified implication of the execution.

15. The system of claim 9, wherein the HSM includes a plurality of physical signal monitors and wherein the HSM is to:
assign a first physical signal monitor of the plurality of physical signal monitors to the first virtual signal monitor.

16. The system of claim 15, wherein the HSM is to:
reassign the first physical signal monitor to a second virtual signal monitor.

17. A method comprising:
instantiating, at a system, a plurality of virtual signals; and
at a first time assigning, at hardware signal monitor circuitry (HSM) of the system, a plurality of physical signals to a first subset of the plurality of virtual signals.

18. The method of claim 17, further comprising:
at a second time, assigning the plurality of physical signals to a second subset of the plurality of virtual signals, the second subset different from the first subset.

19. The method of claim 17, further comprising:
monitoring the plurality of physical signals at the HSM.

20. The method of claim 17, further comprising:
executing, at the HSM, signal operations for the plurality of physical signals in response to signal operation requests associated with the plurality of virtual signals.
